(19) United States
(12) Patent Application Publication
(10) Pub. No.: US 2002/0119255 A1
(43) Pub. Date: Aug. 29, 2002

(54) Method and apparatus for making particle-embedded webs

(76) Inventors: Ranjith Divigalpitiya, London (CA); David E. Livingstone, Harrietsville (CA)

Correspondence Address: Office of Intellectual Property Counsel, 3M Innovative Properties Company, PO Box 33427, St. Paul, MN, 55133-3427, US

(21) Appl. No.: 10/008,468

(22) Filed: Nov. 9, 2001

Related U.S. Application Data
(63) Continuation-in-part of application No. 09/567,316, filed on May 9, 2000.

(51) Int. Cl. B05C 5/00; B05B 7/00; B05C 15/00; B05D 1/02

(52) U.S. Cl. 427/421; 118/300

(57) ABSTRACT

The invention is an apparatus for dispensing particles onto a surface. The apparatus includes a hopper for receiving particles. The hopper includes a hopper opening. The screen is disposed over the hopper opening so as to cover the opening. A brush is disposed approximate to the screen such that bristles on the brush contact the screen.

### CROSS REFERENCE TO RELATED APPLICATION

The present application is a continuation-in-part of U.S. patent application Ser. No. 09/567,316, filed May 9, 2000, which is incorporated by reference in its entirety herein.

### TECHNICAL FIELD

The present invention relates to embedding particles in webs. More particularly, the present invention relates to a process for embedding particles in adhesive films.

### BACKGROUND OF THE INVENTION

Webs containing particles are well known. Typically these webs are films or tapes. Particle-containing films are generally made by dispersing particles into a film precursor before fashioning it into film form. The dispersion technique works well for solvent-based resins and for cross-linkable resins that have a low viscosity in their pre-crosslinked state. Issues with particle dispersion can generally be solved by selecting the processing parameters, such as film precursor viscosity and shear rates.

However, for hot-melt processed resins, particle dispersion can be difficult. If the particles are much smaller than the gaps in the processing equipment, there is little problem. For applications such as anisotropic conductive adhesives, it is not always desirable to use such small particles. Using small particles in these applications, bonding times can be long because of the time it takes for the adhesive to flow to the point where the film thickness equals the diameter of the small particles. It is advantageous to have particles that are closer in size to the adhesive film thickness. However, if the particle size approaches that of the various gaps in the processing equipment (including the compounding equipment and coating apparatus) there can be problems in mixing while maintaining particle integrity, and processing equipment damage can occur. In addition, it is sometimes desirable to have the particles protrude from the surface of the film, such as when making retroreflective films. When curable materials are used in a hot melt process, one must achieve a balance between providing a temperature high enough to yield a viscosity that enables mixing while keeping the temperature low enough to prevent premature curing.

There are known systems which place particles onto a film in a specific pattern as well as in a random pattern. Most involve a first step of separating the particles and a second step of transferring them to a web. Techniques include putting particles into pockets (Calhoun et al. U.S. Pat. No. 5,087,494), passing particles through screens (Sakatsu et al. U.S. Pat. No. 5,616,206), magnetic alignment with ferromagnetic particles (Jin et al. U.S. Pat. No. 4,737,112; Basavanhally U.S. Pat. No. 5,221,417), magnetic alignment of any particle with ferromagnetic fluids (McArdle et al. U.S. Pat. No. 5,851,644; U.S. Pat. No. 5,916,641), stretching a film with close-packed particles on it (Calhoun et al. U.S. Pat. No. 5,240,761), and particle printing (Calhoun et al. U.S. Pat. No. 5,300,340). Another method of transferring particles is taught in EP 0691660 by Goto et al. in which electroconductive particles are electrostatically charged to attract them to an adhering (“silicone-based sticking material”) film through a screen in contact with the film. The screen (or mask) is electrically charged to attract the particles. In this case, the particles coat only those areas not screened off. The screen serves as a selective filter, allowing particles to pass through only in a pattern corresponding to the openings in the screen. The excess particles are brushed or vacuumed off of the screen. The gaps between the distributed electroconductive particles are filled with a photocurable or thermally curable resin to prevent inter-particle electrical connections. Upon curing the resin, the sticking material is stripped away with the mask from the particle filled resin to form an anisotropic electrically conductive resin. These techniques all require significant investment in equipment or various disposable or reusable parts that add cost to the resultant particle-embedded web. The present invention embodies a simpler implementation.

The particles in particle-embedded webs either control the level of adhesion of the film or provide additional utility. For example, if the particles are electrically conductive, a conductive adhesive film can be made. Conductive adhesive films can be used as layers in the assembly of electronic components, such as in attaching flex circuits to printed circuit boards and the like. Z-axis conductive adhesive films are useful in making multiple, discrete electrical interconnections in multi-layer constructions where lateral electrical isolation of the adjacent parts is required. In another example, the particles can be retroreflective, creating retroreflective films. If the particles have no inherent tackiness, the adhesion level of an adhesive web can be controlled by the level of particle loading. Also, the particles could be hollow spheres with encapsulated material, yielding a web with encapsulated material on or near the surface that becomes available upon use.

### SUMMARY OF THE INVENTION

The invention is an apparatus for dispensing particles onto a surface. The apparatus includes a hopper for receiving particles. The hopper includes a hopper opening. The screen is disposed over the hopper opening so as to cover the opening. A brush is disposed approximate to the screen such that bristles on the brush contact the screen.

The invention also includes a method for dispensing particles onto a surface. Particles are held in a hopper having an opening in the screen disposed over the opening. The bristles are brushed or passed across the screen which draws the particles through the screen. Particles are dispersed into the air such that they settle on to the surface.

### BRIEF DESCRIPTION OF THE DRAWINGS

In this disclosure, several devices are illustrated. Throughout the drawings, like reference numerals are used to indicate common features or components of those devices.

FIG. 1 is a schematic view of the apparatus of the present invention.

FIG. 1A is a cross-sectional view of a web with imbedded particles.

FIG. 1B is a cross-sectional view of an alternate embodiment of a web with embedded particles.

FIG. 2 is a perspective view of a feed dispenser that can be used with the apparatus of FIG. 1.

FIG. 3 is a side view of the dispenser of FIG. 2 with the cradle up.

FIG. 4 is a side view of the dispenser of FIG. 2 with the cradle down.

FIG. 4A is a perspective view of one embodiment of a screen.

FIG. 4B is a perspective view of a hopper.

FIG. 4C is a perspective view of a hopper.

FIG. 4D is a cross-sectional view of a hopper.

FIG. 5 is a perspective view of an alternate embodiment of the feed dispenser.

FIG. 6 is a top view of the dispenser of FIG. 5.

FIG. 7 is a front view of the dispenser of FIG. 5.

FIG. 8 is an elevational view of a stationary mandrel.

FIG. 9 is a cross-sectional view of a spring-loaded-mounting mandrel.

FIG. 10 is a schematic view of an alternate embodiment of the present invention.

FIG. 11 is a graph.

FIG. 12 is a partial top view of a web.

FIG. 13 is a partial top view of a web.

FIG. 14 is a micrograph showing silver-coated glass beads embedded onto a thermoplastic adhesive. The sample area is 420 μm×570 μm.

FIG. 15 is a schematic of the test set up used to measure the dispense rate of the particles.

While the above-identified drawing figures set forth several preferred embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principle of the invention.

### DETAILED DESCRIPTION

The invention is a method and apparatus for embedding particles in a web of material. Throughout this description, films, specifically resins in film form, will be described, although other webs, such as paper webs and webs that do not serve an adhesive function can be embedded with particles. The particles need not be spherical or regular and can be completely or partially embedded. They can be any particles that can enhance existing web properties, such as in controlling adhesion, or provide additional utility. The particles can be bare glass beads; expandable microspheres; core/shell particles; metal beads; beads made from oxides, nitrides, sulfates, or silicates such as silver oxide or boron nitride, titania, ferric oxide, silica, magnesium sulfate, calcium sulfate, or beryllium aluminum silicate; hollow glass bubbles; polymeric spheres; ceramic microspheres; magnetic particles; and microencapsulated particles, with any active fill material including releasable drugs, gases, and other materials being encapsulated. The particles can be completely or partially coated with metals, like silver, copper, nickel, gold, palladium, or platinum, or with other materials such as magnetic coating, metal oxides, and metal nitrides. Partial metal coatings can be used, for example, to make particles useful as retroreflective elements. The particles may be microporous or otherwise be designed to have high surface area, including activated carbon particles. The particles can include, within or on the particle, dyes and pigments including afterglow photo-luminescent pigments.

Exemplary particles include those commercially available under the following trade designations: “Reflective Ink 8010” from 3M, St. Paul, Minn.; “Conduct-O-Fil” from Potters Industries, Valley Forge, PA; “Magnapore” from Biopore Corporation, Los Gatos, Calif.; 325 mesh boron nitride from Alfa Aesar, Ward Hill, Mass.; “PLO-PLB6/7 Phosphorescent pigment” from Global Trade Alliance Inc, Scottsdale, Ariz.; “Zeospheres” or “Scotchlite” from 3M and Zeelan Industries Inc., St. Paul, Minn.; “Paraloid EXL2600” from Rolun & Haas, Philadelphia, Pa., and “Novamet Nickel Powder” from Novamet Specialty Products Corporation, Wyckoff, N.J.

The following are examples of application areas in which the invention shows utility. Conductive particles can make a conductive adhesive film which can be used as layers in assembling electronic components, such as adhering flex circuits to printed circuit boards and the like. Z-axis conductive adhesive films (ZAF), made from an adhesive film on a liner, are useful in making electrical connections in multi-layer constructions where lateral electrical isolation of the adjacent parts is required while the layers are to be electrically connected in the z-direction (perpendicular to the plane of the film). When a ZAF is used to make an electrical connection, it is desired to have a particle density of at least six particles per contact pad area. A typical minimum pad size is 0.44 mm². If the particles are chosen to have a diameter comparable to the thickness of the film, the bonding time of the ZAF is fast because less adhesive flow is required to make electrical contact between the particles and the two conductive substrates. In order to make a ZAF using the invention, the conductive particles are embedded into the film after the film has been made. The particles can be dispensed in the presence of an electric field to help distribute the particles as they randomly land on the adhesive film. The electric field creates mutual repulsion of the particles from each other and can also be used to create attraction of the particles to the film. Parts are then bonded by sandwiching the conductive film between two conductors and applying pressure and sometimes heat. Depending on the adhesive type and the size range of the particles, the bonding time, temperature, and pressure vary.

This process of manufacture contrasts with that used for known conductive adhesive films. In most known films, an adhesive precursor is blended with a sufficiently low concentration of conductive particles to assure sufficient particle dispersion to avoid making electrically conductive paths in the x-y plane in the film that is formed after the particles have been blended in. The larger the particles, the more difficult it is to disperse them sufficiently without damaging the particles or the processing equipment. Other methods involve placing the particles on a carrier film, followed by laminating this assembly to the film to be embedded, and subsequent removal of the carrier film. This adds an undesirable extra processing step. U.S. Pat. No. 5,300,340 describes a particle printing process in which the particles can be printed directly onto the final film. However, this is a contact process that results in a uniform (rather than random as in the present invention) ordered pattern. The process speed is limited, and there is no provision to avoid clumping of particles within the printed areas. One disadvantage of this is that the smallest pitch of the circuit lines in the bonded parts have to be larger than in the case of a non-clumping situation. Also, evidence of clumping of two particles means it is quite possible to have a larger cluster of particles.

In another example, the particles can have retroreflective characteristics, to create retroreflective films which are useful for highway signs and in other industries.

A third example of a particle-embedded web involves controlling peel adhesion by adding nonadhesive particles. These webs are useful in making adhesives with controlled adhesion levels.

The particles could also be hollow spheres with encapsulated material which becomes available during use. A film with microencapsulated fragrance can be used for perfume samples. A film with microencapsulated ink can be used as carbonless form paper. The particles can contain magnetic components that can be used as part of a radio frequency identification system to provide information about the item to which they are attached in an efficient, cost-effective manner.

In another example, the web material can be a silicone rubber that will thermally cure during or after embedding the web with particles. The resultant material could be useful as an electrically conductive or thermally conductive pad.

The desired amount of surface area covered by particles will vary by application, and can range from less than 1% up to a monolayer of particles covering the entire surface. The percent coverage provided by a monolayer of particles will depend upon the packing density of the particles, which is in turn related to their shape. For spherical particles, a monolayer of particles corresponds to a percent surface area coverage of approximately 78%. Applications falling within this range include retroreflective sheeting, detackified adhesive films, and z-axis conductive adhesives.

Suitable web materials include those that can be made receptive to the particles while dispensing the particles onto the web. Receptive means that the particles will remain approximately in the positions they assume immediately after being dispensed, until they can be permanently embedded in the web. The web can be a single or multiple layer construction. The web can be a layer of film or other material on top of a carrier layer. When a carrier layer is used, it can be a liner, which can be release coated. Alternatively, a continuous belt could be used as the carrier layer. The web onto which the particles are dispensed need not be continuous, and could be non-woven.

Web materials that are pressure-sensitive adhesives at room temperature can have the particles permanently embedded in the adhesive such as by running the web through a nip roller, with or without pre-heating the film. Nip rollers can be used to embed the particles into any softened web material. By increasing the pressure applied by the nip rollers onto the web material the depth of embedding can be increased. Further softening web materials by pre-heating allows even further embedding of the particles by the nip roller. To overcome potential adhesion of the pre-heated web material to the nip roller, a liner can be interposed between the web material and the nip roller. This liner allows the web material to be pre-heated as well as the pressure of the nip roller to be increased while preventing unwanted adhesion of the web material to the nip roll. Utilizing the liner in combination with the nip roll allows the particles to be embedded at varying degrees up to about 100% embedded (i.e., substantially all particles pushed entirely into the web material).

It is also possible to dispense the particles onto a web made of a liner coated with the reactive precursor of a pressure sensitive adhesive, and then to cure the precursor after the particles have been added. Thermoplastic web materials may require heating to make them receptive. If heating is used, it is desirable to keep the temperature of the web below the temperature at which the thermoplastic will flow off of the liner. Useful thermoplastic films include those designed for use as thermoplastic adhesives, also known as hot-melt adhesives. Any film material that can be cast from solvent can be cast onto a carrier, such as a liner, and have particles embedded before the loss of sufficient solvent to make the film non-receptive. Alternatively, some films may be brushed with solvent to make them receptive before dispensing the particles.

Suitable pressure sensitive adhesive materials can include acrylics, vinyl ethers, natural or synthetic rubber-based materials, poly(alpha-olefins), and silicones. Pressure sensitive adhesives, as defined in the “Glossary of Terms Used in the Pressure Sensitive Tape Industry” provided by the Pressure Sensitive Tape Council, August 1985, are well known. Exemplary pressure sensitive adhesive materials include the acrylic pressure sensitive adhesive tape available from 3M under the trade designation “Scotch® Magic™ Tape 810”, and the rubber-based pressure sensitive adhesive tape available from 3M under the trade designation “Colored Paper Tape 256”.

Thermoplastic materials may be amorphous or semi-crystalline. Suitable thermoplastic materials include acrylics, polycarbonates, polyimides, polyphenylene ether, polyphenylene sulfide, acrylonitrile-butadiene-styrene copolymer (ABS), polyesters, ethylene vinyl acetate (EVA), polyurethanes, polyamides, block copolymers such as styrene-ethylene/butylene-styrene and polyether-block-amides, polyolefins, and derivatives of these. “Derivative” refers to a base molecule with additional substituents that are not reactive toward a crosslinking or polymerization reaction. Blends of thermoplastic materials may also be used. Tackifiers may also be included in the thermoplastic resin. Exemplary thermoplastic materials in film form include those commercially available from 3M under the trade designations “3M Thermo-Bond Film 560”, “3M Thermo-Bond Film 615”, “3M Thermo-Bond Film 770”, and “3M Thermo-Bond Film 870”, those from Adhesive Films Inc. (Pine Brook, N.J.) under the trade designations for series of films “PAF”, EAF”, and “UAF”, and those available from Elf Atochem (Philadelphia, Pa.) under the trade designation “PEBAX 3533”. Suitable tackifier resins include those available under the following trade designations: “TAMINOL 135” from Arakawa Chemical, Chicago, Ill.; “NIREZ 2040” from Arizona Chemical, Panama City, Fla.; or “PICOFYN T” from Hercules Inc., Wilmington, Del.

Thermosetting web materials can also be used. Depending upon the thermosetting material, it is possible that particles could be embedded in a material with an advanced state of cure. However, particularly if the particles cannot be embedded in partially or fully cured material, any heating to make the web receptive must be at a low enough web temperature that the particles can be embedded before the cure advances too far. Suitable thermosetting materials are those that can be made into web form while maintaining latency. Latency means that curing can be substantially prevented until the desired processing can be completed. Achieving this latency might require dark and/or cold processing conditions. Suitable thermosetting materials include epoxides, urethanes, cyanate esters, bismaleimides, phenolics, including nitrile phenolics, and combinations of these. Exemplary thermosetting materials that are commercially available in film form include those available from 3M under the trade designation “3M Scotch-Weld Structural Adhesive Film” including those having the following “AF” designations: “AF 42”, “AF 111”, “AF 126-2”, “AF 163-2”, “AF 3109-2”, “AF 191”, “AF 2635”, “AF 3002”, “AF 3024”, “AF 303OFST”, “AF 10”, “AF 30”, “AF 31”, and “AF 32”.

Hybrid materials also can be used as the web. A hybrid material is a combination of at least two components where the components are compatible in the melt phase (where the combination of the components is a liquid), the components form a interpenetrating polymer network or semi-interpenetrating polymer network, and at least one component becomes infusible (the component cannot be dissolved or melted) after curing by heating or other methods such as light. The first component can be a crosslinkable material and the second component can be (a) a thermoplastic material, or (b) monomers, oligomers, or polymers (and any required curative) which can form a thermoplastic material, or (c) a thermosetting material, i.e., monomers, oligomers, or prepolymers (and any required curative) which can form a thermosetting material. The second component is chosen so that it is not reactive with the first component. It may be desirable, however, to add a third component which may be reactive with either or both of the crosslinkable material and second component to, for example, increase the cohesive strength of the bonded hybrid material.

Suitable first components include thermosetting materials, such as those described above, as well as crosslinkable elastomers such as acrylics and urethanes. Suitable thermoplastic second components include those described above. Suitable thermoplastics, which can be formed in situ, i.e., with monomers, oligomers, or polymers (and any required curative) which can form a thermoplastic material without undergoing any significant crosslinking reaction would be readily apparent. Exemplary hybrid materials incorporating a second component (a) are described, for example, in PCT/EP98/06323, U.S. Pat. No. 5,709,948, and U.S. Ser. No. 09/070,971. Exemplary hybrid materials incorporating a second component (b) are described, for example, in U.S. Pat. No. 5,086,088. Example 1 of U.S. Pat. No. 5,086,088 illustrates an example of a thermoplastic material formed in situ. Suitable thermosetting second components include those described above. Exemplary hybrid materials incorporating a second component (c) are described, for example, in U.S. Pat. No. 5,494,981.

Optionally, the web material may also include additives, such as film-forming materials, intended to improve the film handling properties of the final particle-embedded web. Other examples of additives include thixotropic agents such as fumed silica; core-shell tougheners; pigments such as ferric oxide, brick dust, carbon black, and titanium oxide; fillers such as silica, magnesium sulfate, calcium sulfate, and beryllium aluminum silicate; clays such as betonite; glass beads; bubbles made from glass or phenolic resin; expandable microspheres, for example, microspheres commercially available from Expancel Inc./Akzo Nobel, Duluth, Ga., under the trade designation “Expancel DU”; anti-oxidants; UV-stabilizers; corrosion inhibitors, for example, those commercially available from W.R. Grace GmbH, Worms, Germany under the trade designation “Shieldex AC5”; reinforcing material such as unidirectional, woven, and nonwoven webs of organic and inorganic fibers such as polyester (commercially available from Technical Fibre Products, Slate Hill, N.Y. and from Reemay Inc., Old Hickory, Tenn.), polyimide, glass, polyamide such as poly(p-phenylene terephthalamide) (commercially available from E. I, duPont de Nemours and Co. Inc., Wilmington, Del. under the trade designation “Kevlar”), carbon, and ceramic. Other suitable additives include those that provide thermal or electrical conductivity such as electrically or thermally conductive particles, electrically or thermally conductive woven or non-woven webs, or electrically or thermally conductive fibers. It may also be desirable to provide additives that function as energy absorbers for such curing methods as microwave curing.

The invention uses a technique of dispensing and embedding the particles to provide a random, non-aggregating distribution. The particles are applied at a preselected density with a relatively uniform (number of particles per unit area) distribution of particles. This is accomplished without requiring any complicated screens or masks (although they can be used if desired for certain applications). An electrostatic charge can be applied to aid in the repulsion and mutual exclusion of the particles as they randomly land on the adhesive film. Also, the web can be buffed to further aid in the particle distribution.

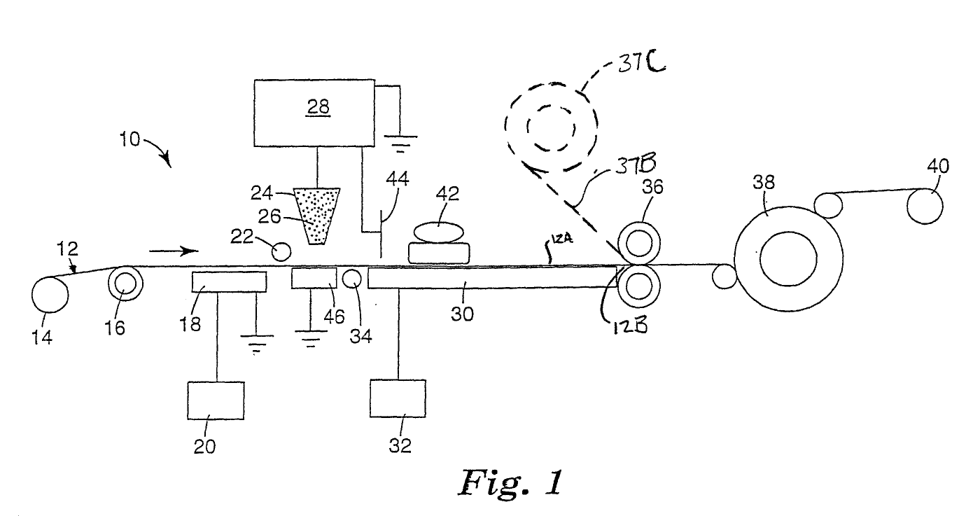

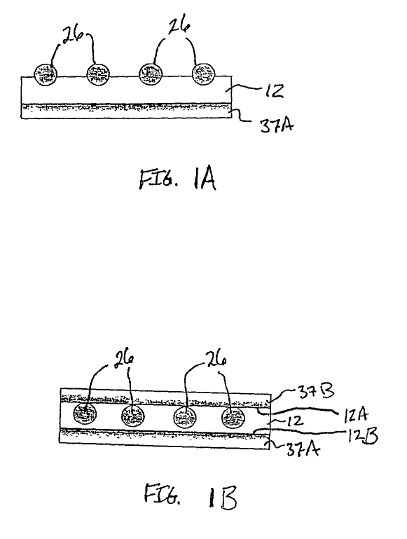

In the system 10, shown in FIG. 1, a web 12, such as an adhesive-coated thermoplastic film, is unwound from a supply roll 14 and travels along a relatively horizontal path, although non-horizontal orientations can be used. Alternatively, the web can be supplied direct from a processing line or in any other known form. Any kind of web unwind device can be used. The web 12 can optionally pass through a pair of nip rollers (not shown), or through or over one or more driven or guide rollers 16. Next, the web 12 passes over a heated surface 18 to soften the web. A temperature sensing device, such as a thermocouple, non-contact infrared sensor, or other similar device, monitors the temperature. The temperature of the heated surface 18 can be used as an indication of the web temperature but more preferably the temperature of the web 12 itself is measured. The heated surface 18 can be governed by a controller 20. The web 12 may contact the heated surface 18, thus being heated by contact, or it can pass above the heated surface, thus being heated by convection. If the web 12 passes above the heated surface 18, static charges created by sliding contact are minimized but more energy is required to heat the web. As shown, the heated surface is an electrical heating plate.

The web 12 next passes by an optional static bar 22 to reduce static charge buildup on the web. Alternatively, ionizing air and other known static elimination devices can be used. Static can already be present on the web from the unwinding of the web or the original coating process.

Next, the web 12 passes the particle dispenser 24 which dispenses particles 26 onto the surface of the web. As shown, an optional voltage source 28 is connected to the particle dispenser 24 to charge the particles 26 before they are dispensed onto the web. The voltage source 28 supplies a voltage sufficiently high to charge the particles 26.

After the particles 26 are deposited onto the surface of the web 12, the web passes over a second heated surface 30, which is governed by a controller 32. Alternatively, a single controller can operate both heated surfaces 18, 30. In another embodiment, a single heated surface can be used. As shown, the each heated surface 18, 30 is an electrical heating plate. Alternatively, other heating devices can be used. For example, the web can pass over a cylindrical roll commonly known as a “hot can”, the web can pass through an oven, or the web can pass over an infrared or induction heater. Heaters can be adjacent the top surface of the web as well as adjacent the bottom surface.

As shown in FIG. 1, the heated surface 18 is used to soften the web 12, or the coating on the web if the web is coated, making the surface tacky. This makes the web 12 receptive to the particles 26 which do not move on the web but are not yet securely fixed to the web. The heated surface 30, shown longer than the heated surface 18, is used to further heat the web 12 to drive the particles 26 into the coating. If multiple heated surfaces are used the relative lengths of the heated surfaces 18, 30 can be varied to accomplish their respective heating tasks. Alternatively, the heated surface 30 can heat the web 12 as the particles 26 are dispensed. Either at the heated surface 30 or after it, another optional static bar 34, or other static elimination device, can be used. The static bar 34, like the static bar 22, can be located over or under the web 12.

From the heated surface 30, in the illustrated embodiment the web 12 travels through a pair of nip rollers 36 which can optionally be driven. The pressure in the nip further drives the particles 26 into the web 12. One or two nip rollers can be used to embed the particles 26 into the web 12. For example, a single roller can be used over a flat plate. Any kind of roller, including silicone rubber, rubber-coated, metal, and combinations or these, can be used as long as they do not crush the particles 26 in the web 12. The nip rollers 36 can also be heated to further drive the particles 26 into the web 12. Also, by heating the nip rollers 36, the heated surface 30 can be shortened and even eliminated. Utilizing this configuration typically allows the particles to be embedded approximately 60% of their diameters into a top surface (or particle surface) 12A, as shown in FIG. 1A. A carrier liner 37A (discussed previously) is illustrated along with the web 12 and particles 26 in FIG. 1A. By increasing and decreasing the pressure in air cylinders (not shown) which drive the nip rollers 36 towards each other, the particles can be embedded into the web 12 to a varying degree.

This precentage of embedding can be increased to about 100%, as shown in FIG. 1B, by further pre-heating the web 12, which results in further softening of the web 12. Since the tackiness of the web typically increases as the softness of the material increases, above a certain temperature the web can stick to the nip rollers 36 which may cause damage to the web 12. To overcome this limitation, a nip liner 37B can optionally be disposed over the heated web 12 between the nip roller 36 and the particle surface 12A of the web 12. The nip liner 37B allows the temperature of the web 12 to be increased up to a temperature where the polymer forming the web is more amenable to flow. The nip liner 37B prevents the material forming the web 12 from adhering to the nip rollers 36 while still allowing the particles to be fully embedded. After the nip rollers 36, the web 12 passes around a drive roller 38 (if the nip rollers 36 are not driven) and to a windup roller 40 at a windup station, such as with an air-clutched winder. Alternatively, the web 12 can optionally pass over a stainless steel pacer roll.

The nip liner 37B can be introduced onto the web 12 prior to translating the web 12 under the nip rollers 36, as illustrated in dotted lines of FIG. 1. The nip liner 37B can be unrolled from a liner supply roll 37C onto the web 12. In the preferred embodiment, the nip liner 37B is comprised of a material which does not show much affinity to the web material. Surprisingly, after the bottom liner 37A and the nip liner 37B are removed from the web 12 with the particles 26 embedded, the web 12 is typically smooth on both its top surface (or particle surface) 12A and bottom surface 12B. Additionally, by using a charged field when dispersing the particles 26 (discussed further below), not more than one particle spans the thickness of the web 12.

The use of the nip liner 37B also allows embedding of particles 26 with the nip rollers 36 when web materials are utilized which are highly flowable at room temperature. One example of this type of material would be a monomer in liquid form such as styrene. Additionally, when uncured resin in the form of a liquid-like layer is used as the web material, the level of embedding can be very high without preheating the web. After the resin is protected with nip liner 37B, the uncured resin and particles 26 are run through nip rollers 36, embedding particles 26 into the resin, and the resin is subsequently cured using various methods, such as by using radiation curing (e.g. UV and e-beam) or thermal curing.

Web materials which are useful for highly embedding particles include, but are not limited to, silicone material such as Dow Corning RTV 732 Multipurpose silicone rubber adhesive sealant, Dow Corning RTV 734 flowable silicone rubber adhesive sealant, 3M Imprint II Quick Step 9572, 9573 (Vinyl polysiloxane) dental impression material, GE Silicone All Purpose Silicone Sealer; thermoplastic elastomers such as polyurethane (Deerfield urethane and Estane™ from Novean).

Aggregation of the particles during dispensing is an obstacle in getting a uniform distribution of particles. Particle clustering is undesirable because it creates paths leading to electrical shorts, uneven retroreflection, uneven tack, and nonuniform appearance. In the known methods used for dispensing particles onto the web, particle aggregation is a common problem. The present invention overcomes this problem. The voltage source 28 can apply a voltage to the dispenser 24 and either an opposite charge or ground can be applied to any combination of the heated surface 18 (grounding is shown), the static bar 34 (grounding is shown), and the heated surface 30. Charging the particles 26 creates an electric field between the dispenser 24 and the heated surface of the web. By imparting a charge to the particles 26, the chance of separating the particles is increased because like charges repel each other. Also, the electric field drives the particles 26 onto the web 12 with sufficient momentum to lodge them into the surface. Third, the geometry of the electric field can restrict the powder fallout beyond the web to minimize waste. Fourth, the charged particles do not “layer” on top of each other with the result that no more than one particle spans the thickness of the polymer layer forming the web.

Another way to promote dispersion is to buff the surface of the web 12 after the particles are dispensed on it. For example, a random orbital sander 42 (Finishing Sander Model 505, available from Porter Cable Company, Jackson Tenn.) fitted with a soft painting pad (available under the trade designation EZ Paintr from EZ Paintr, Weston, Canada and described in U.S. Pat. No. 3,369,268) can be used to spread the powder uniformly over the adhesive. This buffer 42 is also shown in FIG. 1. The inventors have found that as the desired coverage area of the particles increases, buffing becomes a more desirable method of dispersing the particles in the film.

An electrically charged plate 44 can be placed near the dispenser 24 to contain the dispensed powder. The plate 44 may be directly connected to the high voltage power supply 28, or connected to a separate power supply (not shown). A plate 46 which is electrically grounded may be used below the web at the particles dispenser 24. The plate 46 can be electrically heated.

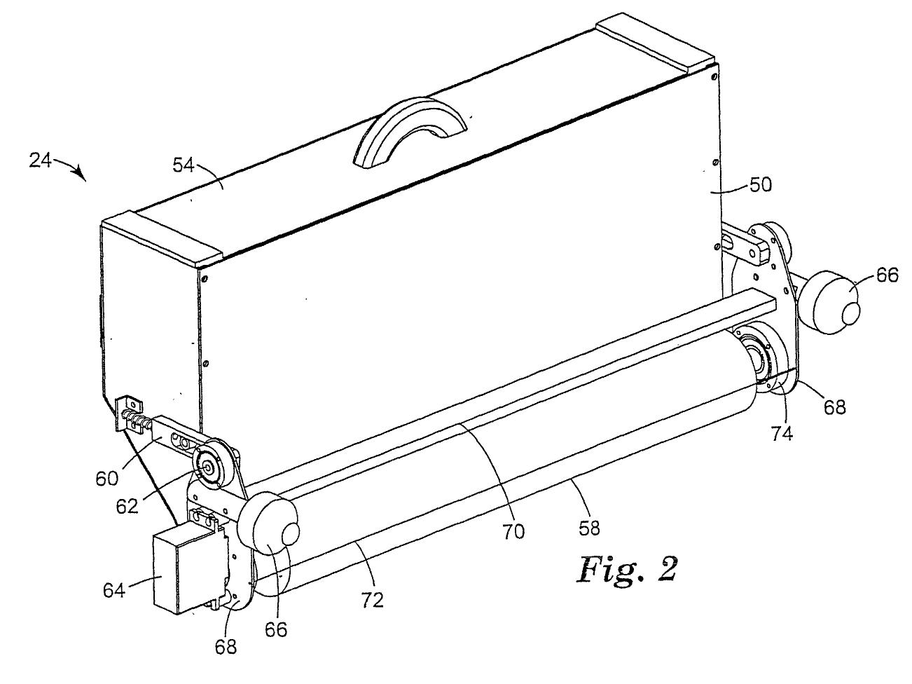

The particle dispenser 24 can include knurled rollers, gravity-fed reservoirs, and vibratory feeders. The system 10 can operate with any of variously known dispensers. The particle dispenser 24 shown in detail in FIGS. 2, 3 and 4 is a novel cradle-type dispenser. It has two main parts, a reservoir called a hopper 50, and a pivoting dispense head, called the cradle 52. The particles 26 to be dispensed are first held in the hopper 50, which can be covered by a lid 54. The hopper 50 can have an angled bottom to promote particle 26 flow to the front of the hopper. An opening 55 on the front face at the bottom of the hopper 50 is covered with a screen 56. The screen openings should be large enough to let the largest particles 26 pass through while being dispensed but small enough to hold the particles back when the dispenser 24 is not operating. In one embodiment, the particles 26 have a mean size of 43 μm and the screen 56 has 80 μm openings but the openings can be 65 to 105 μm (1.5 to 2.5 times the mean particle diameter) or 75 to 86 μm (1.75 to 2 times the mean particle diameter). The screen 56 should have consistent opening size and spacing to ensure even dispensing of particles 26 across the web 12. The screen can be a polyester or metal screen of the type typically used in the screen printing industry. In this embodiment, the screen is a monofilament polyester, PW-180×55 screen manufactured by Saati America's Majestic Division, Somers N.Y.

The cradle 52 includes a dispensing brush 58, adjustable cradle mounts 60, pivot points 62, a geared drive motor (or drive mechanism) 64, counterweights 66, end plates 68, a support bar 70, a cleaning wire 72, and drive bearings 74. The dispensing brush 58 can be cylindrical with ends that permit it to be mounted in the drive bearings 74 and coupled to the drive motor 64. The surface of the brush 58 is covered with very fine, regularly spaced bristles of sufficiently small diameter to extend through the openings in the screen 56. The bristles can be made of polyamide resin or coated with graphite to improve conductivity. The bristles on the brush 58 in this embodiment are nylon, 26 μm in diameter and have a mean length of 0.368 cm (0.145 in). They are arranged in rows of 30.5 tufts/cm (12 tufts/in) with approximately 70 bristles per tuft and 56 rows/cm (22 rows/in) manufactured onto a 0.038 cm (0.015 in) polyester fabric backing by Collins & Aikmen Company, New York, N.Y. If the bristles are not spaced evenly, bristles are missing or removed, or bristles are laid out with irregular patterns, these patterns will be transferred to the web as the particles are dispensed, which can be desirable in certain applications. In one embodiment, the brush 58 has a flat surface and be true so that it contacts the screen evenly across the entire length of the dispenser 24 throughout it rotation. If the brush 58 does not contact the screen evenly, the dispense rate of the particles across the web will vary. Alternatively, the brush can have other configurations. Also, alternatives to the brush can be used, as described further below.

The brush 58 is mounted with sealed drive bearings 74 (bushings can be used) to ensure true rotation. The geared d.c. drive motor 64 (or any equivalent device or drive mechanism, which provides a motivating force to rotate the brush) rotates the brush 58 and controls the rotational speed of the brush by varying the voltage applied to the motor. This determines the dispense rate of the particles. Any other method and device for varying the rotation of the brush can be used. The drive bearings 74, drive motor 64, counterweights 66, and pivot points 62 are mounted to and held together by the end plates 68. The pivot points 62 are sealed bearings to ensure low friction swinging of the cradle 52.

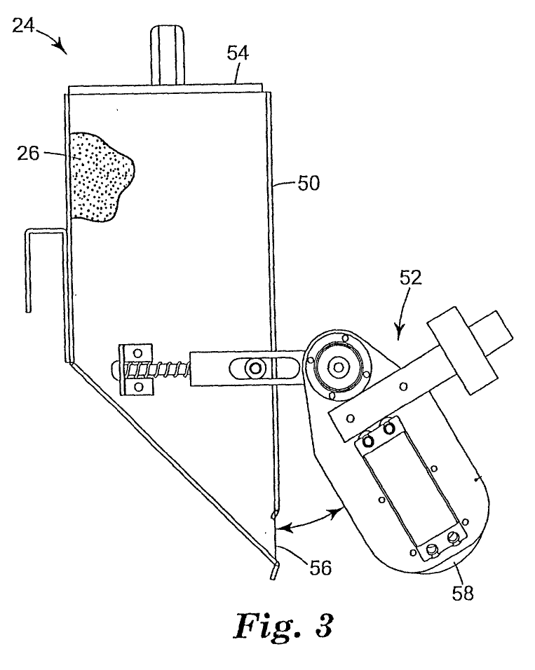

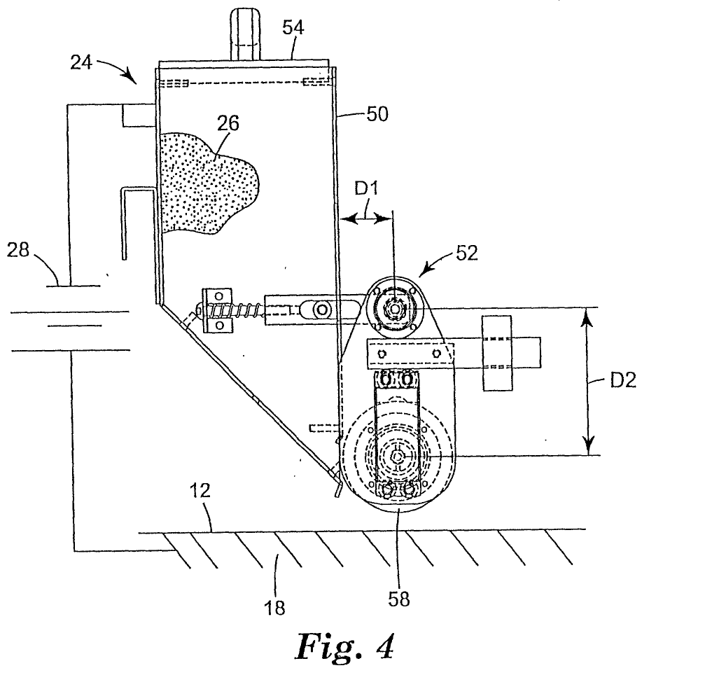

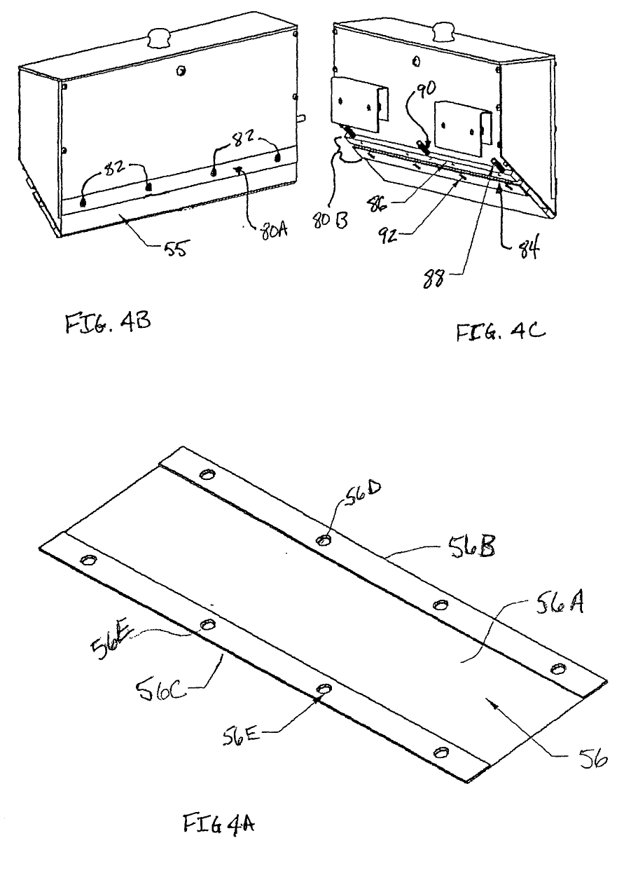

As shown in FIGS. 3 and 4, the entire cradle assembly can pivot freely on the pivot points 62 from the up position (FIG. 3) downwardly until the brush 58 touches the screen 56 (FIG. 4). The cradle 52 is supported at the pivot points 62 by the adjustable cradle mounts 60. In one embodiment, the end plates 68 are structurally bound together by a support bar 70 which makes the ends of the cradle 52 move together to maintain alignment of the brush 58 with the screen 56. In this embodiment, the brush 58 must be precisely aligned with the screen 56 using the adjustable cradle mounts 60. In another embodiment, the end plates are not mounted to adjustable cradle supports but to the support bar which is also able to pivot around its center allowing the brush to move freely and self-align with the screen. The cradle assembly can be pivoted manually or using any known system.

The cradle mounts 60 are adjusted so that the distance, D1, from the screen 56 to the central longitudinal axis of the brush 58 equals the radius of the brush. This ensures that when the cradle 52 is free hanging (without the counterweights 66) the brush surface touches the screen and does not significantly influence the force exerted against the screen. The counterweights 66, which are mounted off-axis at the front of the cradle 52, determine the force with which the brush 58 pushes against the screen 56. This force maintains intimate contact between the brush and screen during rotation and influences the dispense rate. The counterweights 66 can be moved further or closer to the pivot axis between the pivot points 62 on threaded rods to adjust the brush pressure. Alternatively, other known biasing devices can be used. In this embodiment, the dispenser used a pressure of 0.661 kg/linear meter (0.037 lb/linear inch) and had a range of 0.536 to 0.929 kg/linear meter (0.030 to 0.052 lb/linear inch), although other pressures can be used.

The distance, D2, between the pivot axis and the central longitudinal axis of the brush should be equal to the vertical distance from the pivot axis to the center height of the screen to ensure that the brush 58 contacts the screen and not the metal hopper face above or below the screen. A cleaner can remove excess particles from the brush. As shown, the cleaner is a cleaning wire 72, tensioned between the end plates 68 on the front side of the brush 58 so that the wire just contacts the tips of the bristles. As the brush 58 turns and rubs against the cleaning wire 72, any excess particles 26 on the brush are removed to prevent buildup of particles on the brush and possible aggregation of particles on the web 12.

The flatness of the screen 56 over the hopper opening 55 plays an important part in achieving even dispensing of particles 26 across the web 12. If the screen 56 has areas that are unevenly tensioned causing peaks and valleys across the screen 56, the system D will have areas of high dispense rate (i.e., a large number of particles 26 dispensed) at the peaks of screen 56 because the peaks contact the brush 58 first and with the most pressure. Installing the screen 56 with even tension and enough flatness can be a tedious and long task particularly using methods such as manually stretching the screen 56 over the hopper, opening 55 and adhering it in place. Manually attaching the screen 56 has been shown to work but is inconsistent and time consuming. In one embodiment of the inventive system 10 the screen 56 is tensioned evenly across its width during the its life as shown in FIGS. 4A, 4B, 4C and 4D.

FIG. 4A illustrates one embodiment of screen 56. Screen 56 includes a flexible screen portion 56A, a first support bar 56B and a second support bar 56C. First and second support bars 56B and 56C are typically made of aluminum (or other rigid material) and are freely secured to screen portion 56A using an adhesive such as a two-part epoxy. During assembly and curing of the adhesive, the screen portion 56A is tensioned and kept flat (i.e., without wrinkles), and the support bars 56B and 56C are disposed in a substantially parallel fashion. Anchor holes 56D are disposed through first support bar 56B and anchor holes 56E are disposed through second support bar 56C.

One embodiment of hopper 50 is illustrated in FIGS. 4B and 4C, having a front (or first) mounting point 80A which includes front anchors 82, and a rear mounting point 80B which includes a moveable mount 84, a stationary mount 86, adjustment screws 88, springs 90 and rear anchors 92. The rear anchors 92 are attached to the moveable mount 84. The front anchors 82 and rear anchors 92 can be hooks, screws, or any other securing fastener. The moveable mount 84 can translate with respect to the hopper 50. The stationary mount 86 is fixed to the hopper 50.

The adjustment screws 88 protrude through clearance holes in the stationary mount 86 and are screwed into threaded holes in the moveable mount 84. Springs 90 are disposed between ends of adjustment screws 88 and stationary mount 86. As the adjustment screws 88 are tightened into the moveable mount 84, the springs 90 are compressed, which pulls the moveable mount 84 towards the stationary mount 86.

FIG. 4D is a cross-sectional view of one embodiment of the screen 56 mounted to the hopper 50. Anchor holes 56D of first support bar 56B are disposed over front anchors 82 of front mounting point 50A (i.e., on one side of opening 55). Screen portion 56A of screen 56 is stretched over opening 55 in hopper 50. Anchor holes 56E of second support bar 56C are disposed over rear anchors 92 of moveable mount 84 (i.e., on the opposite side of the opening). To release the screen 56 to the rear anchors 92, the adjustment screws 88 are translated in the direction of arrow 94, translating moveable mount 84 in the same direction against the bias of spring 90 and releasing the tension from flexible screen portion 56A, allowing the second support bar 56C or first support bar 56B to be removed from rear anchors 92 (or front anchors 82). Similarly, to secure the screen 56 to hopper 50, the bias of spring 90 is overcome and the moveable mount 84 is translated in the direction of arrow 94. The first and second support bars 56B and 56C are placed over front and rear anchors 92 and 92, respectfully. The adjustment screws 88 and moveable mount 84 are released and the bias of spring 90 translates moveable mount 84 in the direction of arrow 96, tensioning flexible screen portion 56A over opening 55. Since the screen 56 is tensioned by pulling on the rigid support bars 56B and 56C which are adhered across the width of the flexible screen portion 56A, the tension is even across the width of the screen, producing a very flat surface for the interface with the dispensing brush 58 and hereby providing an even dispense rate across the width of the web. The springs 90 maintain this tension during the life of the installed screen 56 improving product consistency and reducing manufacturing down time. Additionally, the rear mounting point acts in quick-release fashion, allowing the operator to quickly attach and remove the screen 56 as necessary (e.g., for cleaning) with a minimum of work required to realign the screen 56 when it is reattached. It should be noted that multiple hopper configurations can be used with this quick release concept, including the positioning of the first and second mounting points 80A and 80B, without departing from the spirit and scope of the invention.

As described, the amount of pressure between the brush and screen affects the particle dispense rate. When parallel, the brush and screen interface surfaces provide even pressure at the interface along its length and therefore even dispensing across the width of the web. Improper alignment typically causes a gradient in the dispense rate which gives a heavy coating on the region that the brush first contacts and a lighter coating on the other areas. Since very small force differences on the order of a few grams can cause changes in the dispense rate, the alignment can take a substantial amount of time.

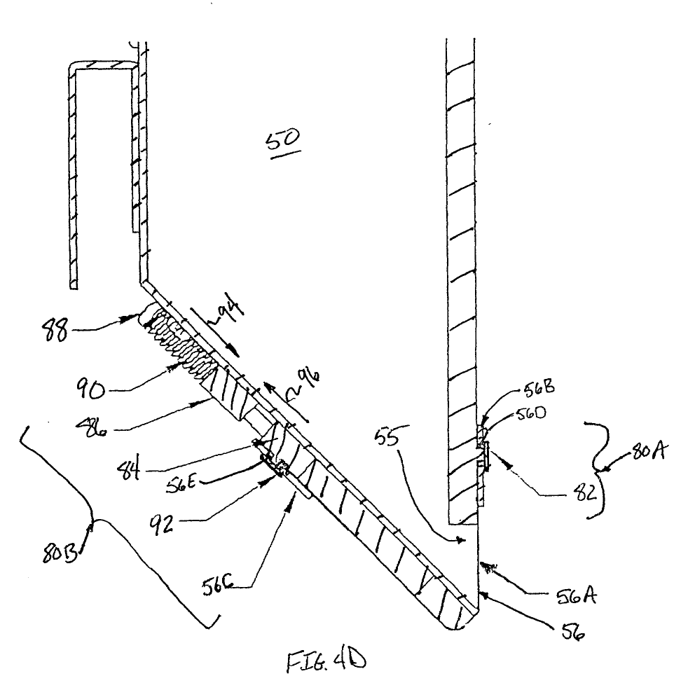

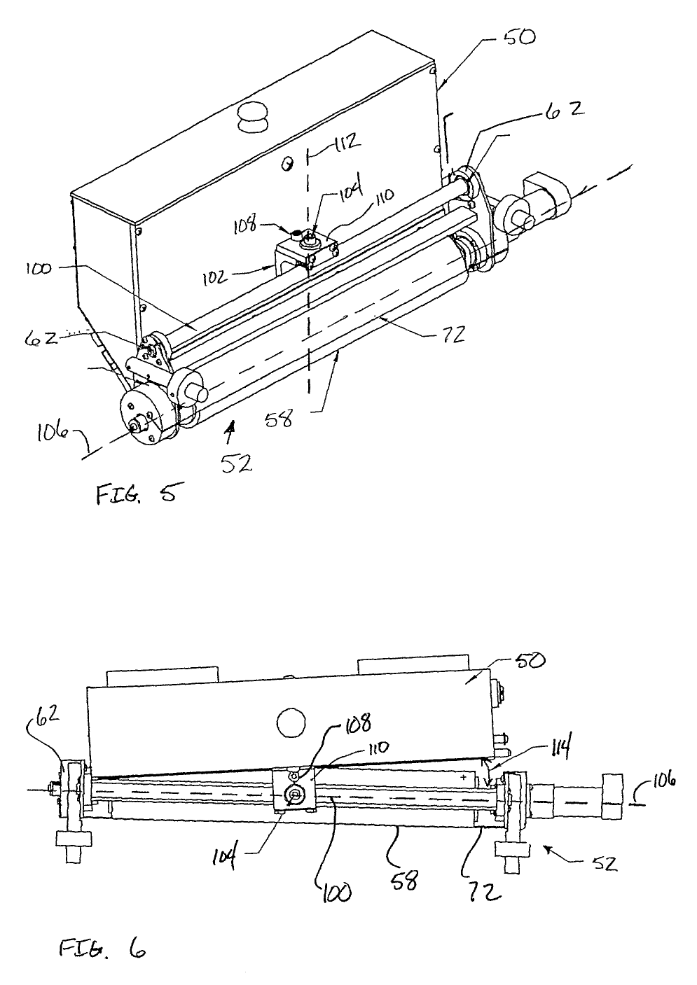

In one embodiment, illustrated in FIG. 5, the brush 58 is no longer mounted using the adjustable cradle mounts (see FIG. 1, reference number 60) but instead has a second support bar 100 which spans between the original pivot points 62 on the end plates 68 of the cradle 52. This second support bar supports the entire cradle 52 and is mounted to the hopper body 50 by an adjustable mount 102 which provides a second pivot mount 104 centrally located along the length of the bar 100. The distance from the screen to a central longitudinal axis 106 of the brush 58 can be adjusted by locating an adjustment screw 108 and translating a top bracket 110 relative to the adjustable mount 102. The cradle additionally can move freely on a second axis pivot 112. This second pivot mount allows the brush to pivot, as illustrated in FIG. 6, arrow 114 in order to “self align” with the screen. This self-aligning provides even and repeatable dispense rates across the entire width of the web without tedious set up and alignment procedures.

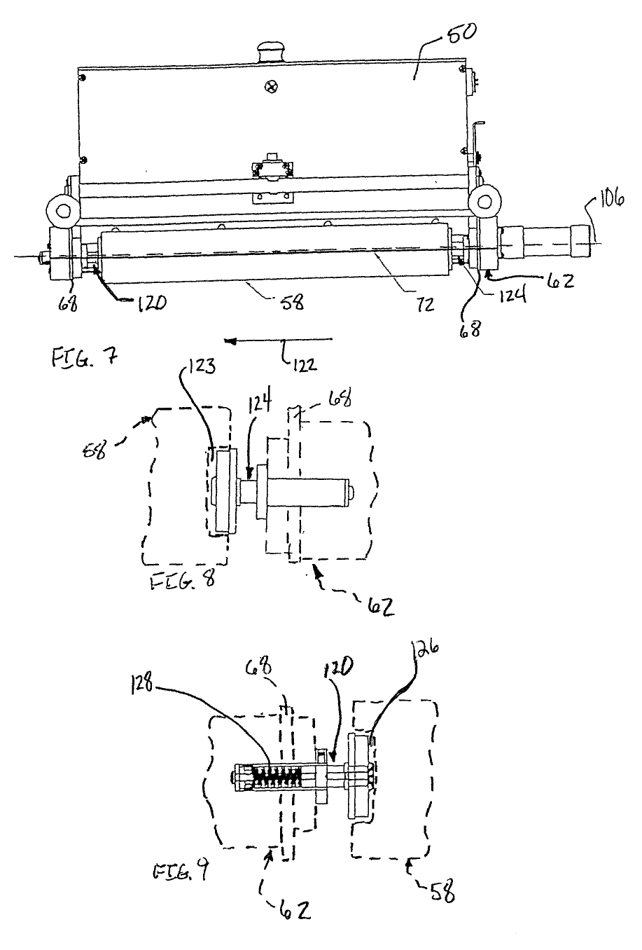

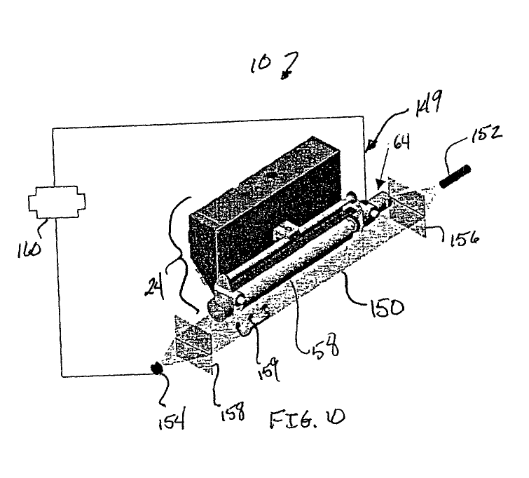

The effects of cleaning wire 72 to brush misalignment, although not as pronounced as brush 58 to screen 56 misalignment, are similar and can additionally cause aggregation of particles 26 on the web 12. A similar, self-aligning methodology as that described with respect to brush to screen alignment can be used for the interface between the cleaning wire and the brush to prevent these problems and eliminate tedious wire alignment procedures. In an alternate embodiment, problems with wire alignment procedures are remedied with the addition of a quick-release mechanism securing the brush 58 to the cradle 52. The quick-change system involves the addition of a spring-loaded mounting mandrel 120, as shown in FIGS. 7, 8, 9 that can be compressed when the brush 58 is forced on its longitudinal axis 106 against the mandrel 120 in the direction of arrow 122. As the spring-loaded mandrel 120 is compressed, a first receptacle 123 in the brush 58 slides off a stationary mandrel 124 at the opposite end of the brush 58 from the spring loaded mandrel 120 (as illustrated in FIG. 8) allowing the brush 58 to be swung down and the spring loaded mandrel 120 to be removed from a second receptacle 126 in the brush 58. Thus, brush 58 can be removed from the cradle 52. This configuration eliminates the necessity of aligning the wire 12 every time the brush 58 has to be replaced because the cradle 52 does not have to be disassembled or the cleaning wire 72 removed. A spring 128 in the mounting mandrel 120 allows the mounting mandrel 120 to be compressed, but also maintains a bias in the direction of arrow 122 during operation helping to maintain tension on the cleaning wire 72 by applying pressure between end plates 68 to which the cleaning wire 72 is mounted. While the embodiment illustrated shows each mandrel 120 and 124 attached to the cradle 52 and sliding out of receptacles in the brush, it should be noted that alternatively one or both mandrels can be mounted to the brush and slid out of the cradle.

As best illustrated in FIG. 4, the dispenser 24 is suspended above the web 12 at a distance close enough to reduce the effects of air currents on the dispense pattern. This distance can be 3 cm from the cleaning wire 72 to the web 12. The hopper 50 is filled with the particles 26 to be dispensed and the lid 54 keeps out contaminants. The voltage is applied to the hopper to charge the particles 26. The drive motor 64 rotates the brush 58 so that the bristles move down across the surface of the screen 56. As the bristles move over the surface of the screen, they protrude through the openings of the screen and draw particles through to the outside, dispensing them onto the web 12. Any particles 26 that remain on the surface of the brush are cleaned off by the cleaning wire 72. The particles that are cleaned off the brush by the cleaning wire fall on to the web forming a second dispense zone. Because the two dispense zones are independent, they tend to further even out particle dispersion.

The dispense rate for a given particle size is affected by the screen opening size, the brush rotational speed, the brush-to-screen pressure, the screen tension, and the proper adjustment of the distance D1. The dispense rate increases as the screen opening size increases, as the brush rotational speed increases, as the screen tension decreases, and as the brush-to-screen pressure increases. As the distance D1 increases, the dispense rate decreases. Depending on the batch of particles (or powder) used, the dispense rate of the particles can vary with time, substantially affecting the particle density of a coated web with position. This variation is undesirable. The variation in the dispense rate can be attributed to the flow properties of the particles. “Sticky” particles that are less free-flowing yields low dispense rates. In some cases the residual fines and debris left on powders can cause plugging up of the screen and lower the dispense rate.

In addition to utilizing the applied voltage, described previously, the dispense rate can be controlled by regulating the rotational speed of the motor (and thus the brush) with a feedback loop employing a monitoring device such as: (a) loss-in-weight monitor, (b) current measurement due to electric charge carried by the dispensed particles, or (c) photodetector that measures extinction of light due to falling particles, among others. A calculation device (or feedback device) receives the signal from the monitoring device, allowing the rotational speed of the brush to be altered accordingly.

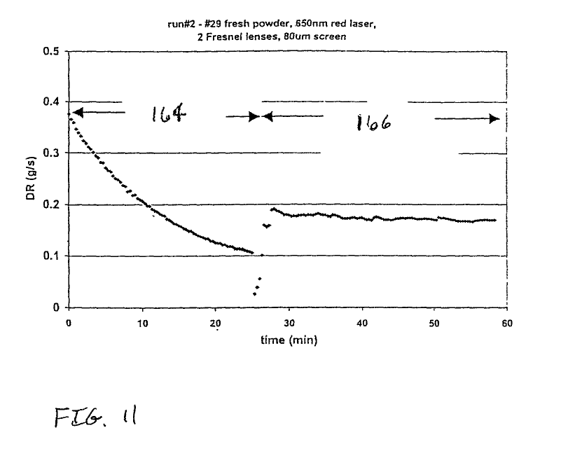

One embodiment of the feedback loop 149 utilizes the optical extinction of a laser beam across the plume of dispensed particles as the monitoring device as illustrated schematically in FIG. 10. The collimated line beam (˜4″ wide and about 2 mm hick) of the laser follows a path 150 from a source 152 to a detector 154 (e.g. a diode laser and a photodetector). The radiation (i.e., light) passes through a first Fresenel lens 156, and through both back and front particle plumes 159 (those due to both the screen/brush and brush/wire interactions). The forward scattered light is collected by a second Fresenel lens 158 and is measured with the detector (e.g. a photodetector). A calculation device 160 such as an electronic feedback circuit as described in The Art of Electronics (Horowitz and Hill. New York: Cambridge University Press, 2^{nd} ed., 1989), or a PLC or computer can be utilized to calculate the rate of particle dispersement from the measured light intensity. The calculation device can then be used to regulate the rotational speed of the motor 64 by outputting a voltage that is proportional to the difference between a reference level and the measured instantaneous light intensity. By introducing a slight delay in responding to the variation of the light intensity, the dispensing rate can be stabilized. The forward scattered light intensity as a function of the dispense rate shows a nearly linear behavior in the limited range of interest in the dispense rates, even though strictly speaking, it varies exponentially with the dispense rate.

In another embodiment, loss-in-weight monitors, which are known in the art, are used as monitoring devices. The particle dispenser can be mounted on more than one force sensor (such as Model 208C01 available from PCB Piezotronics, Depew, N.Y.). For example, one force sensor (or scale) can be mounted at the center of the hopper and one at each end. With the hopper filled with particles, the sensors will output a signal (e.g., voltage) proportional to the total weight of the dispenser. As particles are dispensed, the output of the sensors is received by a calculation device (e.g., feedback circuit) which determines the instantaneous dispense rate. The output of the force sensor is used as the input to the feedback circuit. If the rate is lower than what is needed for the specific web application, the feedback circuit (or PLC or computer) can vary the voltage supplied to the D.C. motor, so as to increase the RPM of the rotating brush.

An alternate embodiment uses a monitoring device which measures the amount of electrical current carried by the particles charged by the voltage source (discussed previously). The current carried by the dispensed particles can be monitored as a voltage across a resistor in series with the voltage power supply at electrical ground. The electrical feedback circuit (or PLC or computer, discussed above) can be used to calculate the dispense rate from the measured current. The feedback circuit can then interface with the d.c. power supply that controls the motor. By varying the gain and the delay in the circuit, an optimized operating condition is obtained that will maintain the particle dispense rate at a constant pre-determined value.

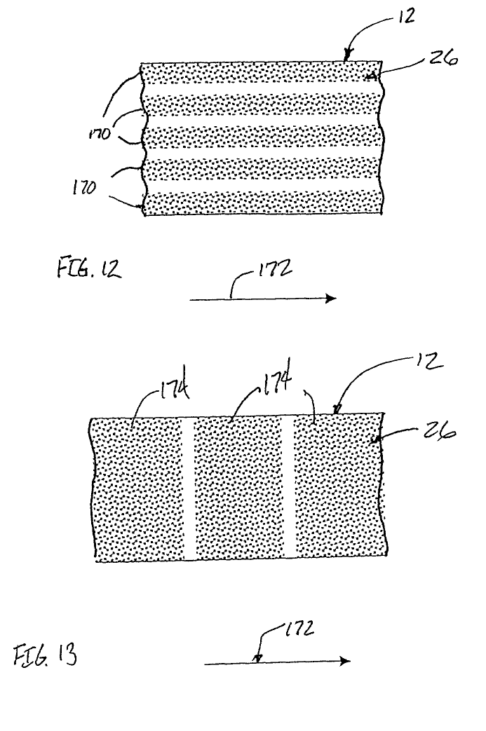

The effect of the feedback loop 149 is shown in FIG. 11, where particles that had very poor flow characteristics in terms of dispensing due to its “sticky” flow behavior was used in the system. The dispense rate vs. time is illustrated both without the feedback 164 followed by system 10 utilizing feedback 166. This clearly indicates that the various feedback methods disclosed act to keep the dispense rate under control at the set value.

As discussed, calculation devices such as the feedback circuits are well known in the art. These devices can also act to control the rotational speed of the motor (and thus the brush). Other alternative calculation devices would include a Programmable Logic Controller (PLC) or other software-driven systems. These and many other alternatives can be effective feedback loop calculation and controlling apparatus.

The uniformity of coating weight across the web and dispersion of particles on the web are affected by brush-to-screen alignment, brush cleanliness, brush surface regularity, voltage and feedback in the following ways. Misaligning the brush and screen will cause heavier dispensing where the brush first touches the screen. Contaminated areas on the brush surface and areas on the brush surface that have less bristle density will decrease the dispense rate at those areas. Without the voltage source, particle dispersion decreases and aggregation increases. Feedback prevents loss of flow due to variation in powder behavior.

Another embodiment of the present invention allows for a variation in particle disbursement onto selected areas of the web. For example, it may be desirable to coat the web 12 in such a fashion that the particles are coated in the form of stripes along the length of the web as the web 12 is translated in direction indicated by arrow 172, as illustrated in FIG. 12.

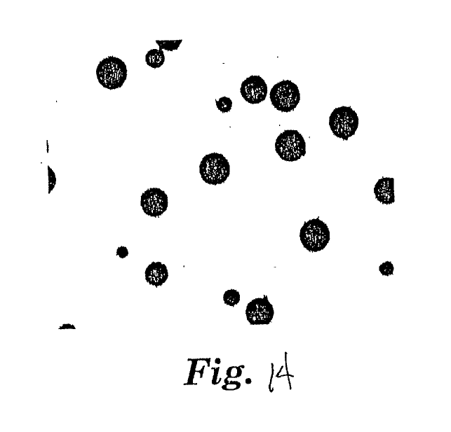

Alternatively, it may be desirable to vary the dispersement of particles 26 onto the web 12 such that a predetermined length of the web 12 is coated, as illustrated in FIG. 13. As web 12 is translated in the direction of arrow 172 cross web stripes 174 are coated onto web 12 such that an area across the web remains uncoated.

Embedding particles in selected areas of the web can be accomplished by using a mask (not shown) on the screen in the particle dispenser which corresponds to the desired web pattern. The geometrical parameters of the pattern can be varied as needed. The screen mask can be prepared by photolithography, or by placing a prepared mask of suitable material such as a thin metal or rigid plastic sheet in close proximity with the screen, thereby preventing particles from passing through the screen onto the web. Alternately, the corresponding pattern can be cut into the rotating brush such that in the areas where no particles are to be embedded, the bristles are not touching the screen. In another embodiment of this invention, circular metal or plastic sleeves with proper dimensions, can be placed over the brush to delineate the pattern. The dimensions involved are not limiting and could be determined by a person who is knowledgeable in the art.

In a further embodiment, particles can be embedded in certain regions of the web such that certain regions of the web are uncoated, by utilizing a mechanical shutter inside the particle container, in very close proximity to the screen. By opening and closing the shutter at selected time intervals, patterns transverse to the travel direction of the web can be formed on the web.

In an alternative embodiment, the brush can be replaced by a knurled roller, such as used in printing industry. In another alternative embodiment, the screen is placed horizontally at the bottom of a hopper 50 and a brush is placed in contact with the screen. The powder (particles) in the hopper 50 dispenses as the brush rotates in contact with the screen by dragging the particles through the screen. Because this can lead to powder build up and impaction at the base of the bristles which eventually falls out in clumps onto the web, another screen can be placed horizontally at the bottom of the device to contact the brush as well. The second screen is below the brush and can assist in reducing aggregation if particles by breaking the clumps as they are forced through the bottom screen.

In another embodiment, a vibratory dispenser can be used to dispense powder. By modifying the path to make it resistant to the flow of the powder in the vibratory dispenser, the dispense rate can be moderated. In one version, the path of the powder in the dispenser is modified by attaching a “hook” material (such as can be found in known hook and loop fasteners) in the path of the powder flow. This slows the dispense rate due to the restriction posed by the hooks to the flow of powder. The dispense rate can be moderated by using various grades of the hook material. Various microstructured surfaces could be used in the place of the hook material to modify the flow of particles. A linear relationship between the operating a.c. voltage of the vibratory dispenser and the powder dispense rate was established for a given flow medium.

One advantage of the invention is that it simplifies the manufacturing process by eliminating the problem of particle aggregation. This is particularly advantageous when embedding conductive particles. FIG. 14 is a micrograph showing silver coated glass beads embedded onto a thermoplastic adhesive. The sample area is 420 μm×570 μm. An ancillary benefit to this more uniform particle distribution is that it provides a uniform appearance in the finished product.

An advantage of using the inventive method to make z-axis conductive adhesive films is that it allows the use of large conductive particles. Because the size of the particles can be very similar to the thickness of the adhesive film, and because the particles span the thickness of the adhesive, the amount of material flow to make a bond is minimal, especially when compared to known thermoplastic-film based systems in which the particles are small compared to the thickness of the adhesive. This allows quick bonding of the conductive surface. This also ensures that the thickness of the final bond is uniform over a large part. This can help maintain the quality of a final product.

Another advantage of a z-axis conductive adhesive film made via the inventive process is that the embedded-particle film product can be based on thermoplastic adhesive. The tack of the adhesive can be reactivated by heating. This can be done as many times as needed. Freedom to reactivate the adhesive is useful in applications where the bonded parts have to be reworked, removed, repaired, or repositioned.

### Test Methods

Peel Adhesion Strength

Peel adhesion strength to a glass substrate was measured. An IMASS Tester, Model 3M90 (available from IMASS Instrumentors, Incorporated, Strongville, Ohio) was used to measure the 180° angle peel adhesion strength as follows. First, the glass plate test surface of the peel tester was cleaned using methyl ethyl ketone and KIMWIPES EX-L tissues (available from Kimberly-Clark Corporation, Roswell, Ga.). Next, a sample having a width of 1.9 cm (0.75 in) and a length of 25.4 cm (10.0 in) was placed lengthwise on the glass plate. The sample was secured to the glass substrate by passing a 2.27 kg (5 lb) rubber roller back and forth over the sample three times. Next, the sensor arm was extended lengthwise over the sample and the end furthest from the arm holder was attached to the sample. The opposite end of the sensor arm was then positioned in the arm holder and the tester was activated. The sample was peeled from the glass substrate at an angle of 180° and a rate of 229 cm/min (90 in/min).

The first 2 seconds of data were not included in the analysis, to accommodate the startup of the test. The data taken between 2 and 5 seconds was analyzed for the average peel force, converted to a peel adhesion strength value, and normalized to a width of 2.5 cm (1 in). Four samples were measured and the results used to calculate the reported overall average peel adhesion strength (in gm/cm (oz/in)) and standard deviation.

Surface Area Coverage

The surface area covered by embedded particles was evaluated using a microscope. Articles having embedded particles on their surface were examined at 20× magnification using an OLYMPUS BX60 F5 (available from Olympus Optical Company, Ltd., Japan) microscope equipped with a video camera. A picture was taken at 366× magnification of a randomly selected area and the image stored in a digital format for later manipulation. Six images, each having an area of 0.24 mm², were analyzed using SIGMASCAN PRO 5 image processing software (available from SPSS, Incorporated, Chicago, Ill.) to obtain a particle count in each of six randomly selected areas and an average particle count was calculated. The percentage of surface area covered was determined by multiplying the average cross-sectional area of a particle (obtained from the average particle size provided by the manufacturer) by the average total particle count in an imaged area, and dividing this number by the total area of the image. This number is multiplied by 100 to obtain the percentage.

Electrical Resistivity

Articles having electrically conductive particles were evaluated for electrical resistance both through the thickness of the article (z axis) and across its surface (x-y plane, also referred to as “sheet resistance”). More specifically, for z axis resistivity, a film sample, having a width of about 15.2 cm (6 in) and a length of about 25.4 cm (10 in), was placed between two circular brass plates 0.318 cm (0.125 in) thick and having a diameter of 2.5 cm (1 in). The electrodes of a FLUKE 83 III Multimeter (available from FLUKE Corporation, Everett, Wash.) were attached to the brass plates which were then pressed together using finger pressure. The z axis resistance was recorded in ohms.

The x-y plane (sheet) resistance of a sample having the dimensions above was measured using a PROSTAT Surface Resistance & Resistivity Indicator, Model PSI-870 (PROSTAT Corporation, Bensenville, Ill.) by following the procedure described in the operations manual. The x-y plane resistance was recorded in ohms/square (also written as ohms/□).

Retroreflectivity

Retroreflectivity of the coated samples were measured using a Field Retroreflectometer Model 920 available from Advanced Retro Technology Inc., Spring Valley, Calif. The retroreflectivity is expressed in candles per lux per square meter (cd/lx/m²). First, the instrument was calibrated using a standard sample provided by the manufacturer (Engineering White) by placing the instrument over the sample (such that its optical window fits the samples) and reading the digital display on the instrument. The calibration knob was adjusted until the instrument read 101.0 cd/lx/m². Then the instrument was placed over the sample to be measured in the same way and the retroreflectivity was provided. Three areas of the coated samples, 10 cm (4 in) apart from each other, were measured and averaged before reporting.

Particle Embedment

The depth to which the particles are imbedded in the web was evaluated using an optical microscope. Cross sectional images of articles having embedded particles were examined at 20× magnification using an OLYMPUS BX60 F5 (available from Olympus Optical Company, Ltd., Japan) microscope equipped with a video camera. A picture was taken at 366× magnification of an edge-on view of a randomly selected area and the image stored in a digital format for later manipulation. Six images, each having an edge-on area of about 0.24 mm were analyzed using SIGMASCAN PRO 5 image processing software (available from SPSS, Incorporated, Chicago, Ill.) to obtain a particle depth embedment and a particle diameter for each particle in each of six randomly selected areas. An average depth of particle embedment and an average particle diameter were calculated.

The percentage of particle embedment was determined by dividing the average depth of particle embedment by the average diameter of the particles and then multiplying this result by 100 to obtain the percentage. “100% embedment” means that the particles are contained entirely in the web material, and/or the particles are level with the surface of the web, and/or substantially no portion of the particle extends from the web surface.

### EXAMPLES

In the examples 1-10 and Comparative Example below, various coated webs were embedded with particles using the apparatus of FIGS. 1-4. For some of the examples, dispensing was conducted in conjunction with buffing, electrostatic charging, or both. All of the examples were performed in a humidity-controlled environment. Typical relative humidity inside the apparatus was kept below 10% and the ambient temperature around 30° C.

### Example 1

A sample of Scotch® Magic™ Tape 810 (an acrylic pressure sensitive adhesive tape) measuring 1.9 cm (0.75 in) wide and 25.4 cm (10 in) long was embedded on the adhesive surface with uncoated Conduct-O-Fil™ S-3000-S3P glass beads (an intermediate in the production of metal coated glass beads), available from Potters Industries, having an average particle diameter of 43 μm. The dispenser used was similar to that shown in FIGS. 2-4 and various surface area coverages were used. The following parameters were used: a web speed of 6.1 m/min (20 ft/min), electrically grounded heating plate temperature of about 20-25° C., a distance of 30 mm between the charging wire on the brush and the heating plate, an operating voltage of 0.4 V for rotating the brush, and a negative d.c. potential of 7 kV applied to the dispensing apparatus. The screen was kept taut by stretching it manually over the dispenser opening until there was no appreciable slack when pressed with a finger. The resulting particle embedded article was evaluated for surface area coverage and peel adhesion strength as described in the “Test Methods” above. The results are reported in Table 1 below.

### Example 2

Example 1 was repeated with a web speed of 9.1 m/min (30 ft/min). The resulting particle embedded article was evaluated for surface area coverage and peel adhesion strength as described in the “Test Methods” above. The results are reported in Table 1 below.

### Example 3

Example 1 was repeated with a web speed of 12.2 m/min (40 ft/min). The resulting particle embedded article was evaluated for surface area coverage and peel adhesion strength as described in the “Test Methods” above. The results are reported in Table 1 below.

### Comparative Example

A sample of Scotch® Magic™ Tape 810 was evaluated for surface area coverage and peel adhesion strength as described in the “Test Methods” above. The results are reported in Table 1 below.

TABLE 1

| | | | | | Peel Adhesion |
|---|---|---|---|---|---|
| | | | Dispensing | % Surface Area | Strength |
| Ex. | Substrate Type | Particle Type | Method | Covered | gm/cm (oz/in) |
| 1 | acrylic PSA tape | Uncoated | Dispensing and | 40 | 0 |
| | | glass beads | electrostatic | | (Completely |
| | | | charging | | Detackified) |
| 2 | Same | Same | Same | 9 | 3.3 ± 1.1 |
| | | | | | (0.3 ± 0.1) |
| 3 | Same | Same | Same | 1 | 33.5 ± 11.1 |
| | | | | | (3 ± 1) |
| CE | Same | None | None | 0 | 256.7 ± 122.8 |
| | | | | | (23 ± 11) |

CE = Comparative Example

### Example 4

A 1:1 (by weight) blend of a resin material having the trade designation PEBAX 3533 (a polyamide-polyether block copolymer, available from Elf Atochem, North America, Philadelphia, Pa.) and a resin material having the trade designation NIREZ 2040 (a terpene phenolic, available from Arizona Chemical Corporation) was extruded onto a 0.002 in thick silicone-coated polyester film to provide a thermoplastic film having a thickness of 0.0025 in on the release liner.

The thermoplastic film was embedded with conductive silver-coated glass beads, S-3000-S3P (available from Potters Industries) having an average particle diameter of 43 μm by passing the thermoplastic film on the release liner through the dispensing apparatus similar to that described in Example 1. The following parameters were used: a web speed of 6.1 m/min (20 ft/min), a heating plate temperature of 85° C. (maintained using a Temperature Controller Model 89810-02, available from Cole-Parmer Instrument Company, Vernon Hills, Ill.), a distance of 30 mm between the charging wire on the brush and the heating plate, and an operating voltage of 0.4 V for rotating the brush. The screen was kept taut by stretching it manually over the dispenser opening until there was no appreciable slack when pressed with a finger. The coated web was sent through the nip of two silicone rubber rolls. The resulting particle embedded article was evaluated for surface area coverage and resistivity as described in the “Test Methods” above. The results are reported in Table 2 below.

### Example 5

Example 4 was repeated with a negative d.c. potential of 7 kV applied to the dispensing apparatus, and with the heating plate grounded. The resulting particle embedded article was evaluated for surface area coverage and resistivity as described in the “Test Methods” above. The results are reported in Table 2 below.

### Example 6

Example 5 was repeated with the particle-embedded thermoplastic film buffed on the particle-containing surface using a finishing sander (Model 505, available from Porter Cable Jackson, Tenn.) equipped with an EZ Paintr® pad. The buffing occurred 7.5 cm (3 in) away form the powder dispensing area of the web. The resulting particle embedded article was evaluated for surface area coverage and resistivity as described in the “Test Methods” above. The results are reported in Table 2 below.

TABLE 2

| | | | | % Surface | |
|---|---|---|---|---|---|
| | Substrate | Particle | Dispensing | Area | |
| Ex. | Type | Type | Method | Covered | Resistivity |
| 4 | Thermoplastic resin | Silver-coated | Dispensing | 4 | z axis: 0.5 ohms |
| | | Glass Beads | | | x-y plane: 10¹¹ ohms/□ |
| 5 | Same | Same | Dispensing & | 17 | z axis: 0.4 ohms |
| | | | electrostatic | | x-y plane: 10¹¹ ohms/□ |
| | | | charging | | |
| 6 | Same | Same | Dispensing & | 48 | z axis: 0.4 ohms |
| | | | electrostatic | | x-y plane: 10¹¹ ohms/□ |
| | | | charging & | | |
| | | | buffing | | |

### Example 7

A rubber adhesive-based tape was embedded with reflective particles and evaluated for retroreflectivity. (Retroreflectivity is a special case of reflectivity; it describes reflection of incident light back at an angle of 180°. Specifically, 3M™ Colored Paper Tape 256 (a printable flatback paper tape) was embedded on the adhesive surface with glass beads hemispherically coated with aluminum (available as Component B of 3M™ Reflective Ink 8010) using the apparatus and parameters described in Example 1 with the following modification. The operating voltage for rotating the brush was 1.5 V. The resulting particle embedded article was evaluated for surface area coverage and retroreflectivity as described in the “Test Methods” above. The results are reported in Table 3 below.

### Example 8

Example 7 was repeated with an operating voltage for rotating the brush of 3.0 V. The resulting particle embedded article was evaluated for surface area coverage and retroreflectivity as described in the “Test Methods” above. The results are reported in Table 3 below.

### Example 9

Example 7 was repeated with an operating voltage for rotating the brush of 6.0 V. The resulting particle embedded article was evaluated for surface area coverage and retroreflectivity as described in the “Test Methods” above. The results are reported in Table 3 below.

### Example 10

Example 9 was repeated with 3M™ Structural Bonding Tape 9245 (a heat curable, epoxy/acrylic hybrid pressure sensitive adhesive tape) used in place of 3M™ Colored Paper Tape 256. The resulting particle embedded article was evaluated for surface area coverage and retroreflectivity as described in the “Test Methods” above. The results are reported in Table 3 below.

TABLE 3

| | | | | % Surface | |
|---|---|---|---|---|---|
| | | | Dispensing | Area | Retroreflectivity |
| Ex. | Substrate Type | Particle Type | Method | Covered | (cd/lx/m²) |
| 7 | Rubber adhesive | Aluminum coated | Dispensing & | 14 | 16.2 ± 4.4 |
| | tape | glass beads | electrostatic | | |
| | | | charging | | |
| 8 | Same | Same | Same | 33 | 36.8 ± 16.6 |
| 9 | Same | Same | Same | 50 | 60.5 ± 30.1 |
| 10 | Hybrid PSA tape | Same | Same | 60 | 66.4 ± 35.4 |

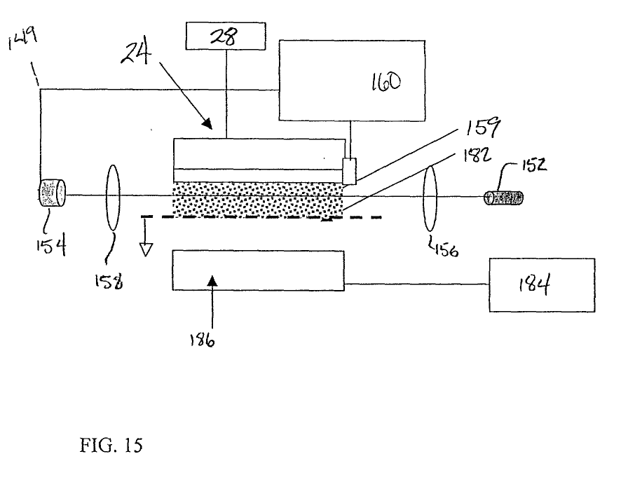

In the examples 11-14 below, various coated webs were embedded with particles using the apparatus of FIG. 1. For some of the examples, dispensing was conducted in conjunction with buffing, electrostatic charging, or both. All of the examples were performed in a humidity-controlled environment. Typical relative humidity inside the apparatus was kept below 10% and the ambient temperature around 30° C. FIG. 15 illustrates the test set up used to measure the dispense rate of the particles.

The improved dispenser 24 was mounted over a metal screen 182 parallel to the bottom of the rotating brush. The screen was electrically ground and −7 kV was applied via the voltage source 28 to the dispenser body. The metal mesh allowed particles to fall onto an electronic balance 186 (OHAUS Precision Advanced Model GT4100 from Ohaus Corporation, Florham Park, N.J.) below it without accumulating. This simulated dispensing particles onto a moving web where the particles are carried away from beneath the dispenser. A personal computer 184 (PC) connected to the balance recorded the mass of falling particles (particle plume 159) with time allowing the instantaneous dispense rate to be determined.

To control the dispense rate of the particles, a 650 nanometer diode laser 152 line generator (ULL12-3.5G-650-15 available from World Star Tech of Toronto, Ontario, Canada) was mounted on the side of the dispenser with a Fresenel lens 156 between the laser and the dispenser as shown. This allowed probing of the particle plume. The fan angle of the laser was 15°. The laser was kept at the focal point of the first lens, and by adjusting the distance between the lens and the dispenser, most of the particle plume was probed by the laser beam. The light passing through the plume was collected with another Fresenel lens 158 on the other side of the dispenser and was measured with an optical power meter (NEWPORT Model 1815-C, available from Newport Canada, Mississauga. Ontario). The output of the power meter was used to control the rotation speed of the dispenser motor with a feedback loop 149 (or feedback circuit).

### Example 11

A series of samples embedded with particles were prepared from a thermoplastic adhesive, PEBAX 3533 (a polyamide-polyether block copolymer, available from Elf Atochem, North America, Philadelphia, Pa.) as follows.

A 1:1 (by weight) blend of a resin material having the trade designation PEBAX 3533 (a polyamide-polyether block copolymer, available from Elf Atochem, North America, Philadelphia, Pa.) and a resin material having the trade designation NIREZ 2040 (a terpene phenolic, available from Arizona Chemical Corporation) was extruded onto a 0.051 mm (0.002 inch) thick silicone-coated polyester film to provide a thermoplastic film having a thickness of 0.0635 mm (0.0025 inch) on the release liner.

The thermoplastic film was embedded with conductive silver-coated glass beads, Conduct-O-Fil™ S-3000-S3P (available from Potters Industries), having an average particle diameter of 43 micrometers by passing the thermoplastic film on the release liner through an apparatus similar to that described in FIG. 1 including a dispensing apparatus similar to that described in FIG. 5. The following parameters were used: a web speed of 4.57 m/min (15 ft/min), a distance of 3 mm between the charging wire on the brush and the heating plate, an operating voltage of 0.4 V for rotating the brush, and a negative d.c. potential of 7 kV applied to the dispensing apparatus. The particles were dispensed onto The PEBAX film at a despense rate of 0.2 grams/second. The air pressure on the nip rolls was varied from 0.138 MPa (20 psi) to 0.276 MPa (40 psi) in increments of 0.069 (10 psi). The temperature of the heating plate (maintained using a Temperature Controller Model 89810-2, available from Cole-Parmer Instrument Company, Vernon Hills, Ill.) was set at 70° C., 80° C., or 90° C. as specified in Table 4 below. At temperatures above about 90° C., the film began to stick to the upper rubber nip roll.

The resulting particle embedded articles were evaluated for Particle Embedment as described in the “Test Methods” above. The results are reported in Table 4 below.

TABLE 4

| Nip Roll Pressure, | Temperature of | % Particle Embedment |
|---|---|---|
| MPa (psi) | Hot Plate, ° C. | (average) |
| 0.138 (20) | 70 | 33 |
| | 80 | 46 |
| | 90 | 53 |
| 0.207 (30) | 70 | 44 |
| | 80 | 48 |
| | 90 | 53 |
| 0.276(40) | 70 | 50 |
| | 80 | 55 |

### Example 12

DOW CORNING White RTV 110 flowable silicone rubber adhesive sealant, available from Dow Corning Corporation, Mississauga, Ontario Canada L5N 2M1, was coated onto a polyester web 0.025 mm (0.001 inch) thick available from Cadillac Plastics, London. Ontario) to provide a film having a thickness of 0.0635 mm (0.0025 inch) on the release liner using a Mayer bar.

Conductive silver-coated glass beads were embedded using the apparatus and procedure of Example 11 while the sealant coating was still tacky.

Conduct-O-Fil™ S-3000-S3P, (available from Potters Industries) having an average particle diameter of 43 micrometers was used in this example with the apparatus similar to that described in FIG. 1. The following parameters were used: a web speed of 4.57 m/min (15 ft/min), a distance of 3 mm between the charging wire on the brush and the heating plate, an operating voltage of 0.4 V for rotating the brush, and a negative d.c. potential of 7 kV applied to the dispensing apparatus. The particles were dispensed onto the film at a dispense rate of 0.2 grams/second. A 0.025 mm (0.001 inch) thick polyester (PET) liner (available from Cadillac Plastics, London. Ontario) as placed on the top of the particle sprinkled web and then passed through the nip rolls.

The air pressure on the nip rolls was 0.138 MPa (20 psi). Coating was done at room temperature.

The resulting particle embedded film was heated in an air circulating oven for about two hours at 60° C. to cure the sealant.

The resulting particle embedded article was evaluated for Particle Embedment as described in the “Test Methods” above. The resulting web was smooth to the touch and appeared smooth as well. Microscopic examination revealed that the particles were completely embedded in the silicone sealant.

### Example 13

DOW CORNING RTV Silicone 734 flowable silicone rubber adhesive sealant, available from Dow Corning Corporation, Mississauga, Ontario Canada L5N 2M1, was knife coated on a polyester film with the coating gap set to 0.051 mm (0.002 inches). Conduct-O-Fil™ S-3000-S3P silver coated glass beads having an average particle diameter of 43 micrometers were dispensed as in Example 11.

The resulting particle embedded film was allowed to dwell for about two hours at room temperature (about 22° C.) to cure the sealant.

The resulting particle embedded article was evaluated for Particle Embedment as described in the “Test Methods” above. Microscopic examination showed that the particles were 100% embedded.

### Example 14

DOW CORNING RTV Silicone 734 was knife coated on a polyester liner with the coating gap set to 0.025 mm (0.001 inch). Particles were dispensed as in Example 11.

Conduct-O-Fil™ S-3000-S3P silver coated glass beads having an average particle diameter of 20 micrometers were used. A 0.025 mm (0.001 inch) thick PET liner was placed on the top of the particle sprinkled web and passed through the nip set at 0.138 MPa (20 psi).

The resulting particle embedded film was allowed to dwell for about two hours at room temperature (about 22° C.) to cure the sealant.

The resulting particle embedded article was evaluated for Particle Embedment as described in the “Test Methods” above. Microscopic examination showed that the particles were 100% embedded.

Various changes and modifications can be made in the invention without departing from the scope or spirit of the invention. All cited materials are incorporated into this disclosure by reference.

1. An apparatus for dispensing particles onto a surface comprising:
a hopper for receiving particles including:
a hopper opening;
a screen disposed so as to cover the hopper opening; and
a brush disposed proximate to the screen such that bristles on the brush contact the screen;
a cradle rotatably supporting the brush wherein the brush includes a longitudinal axis; and
a pivot mount secured to the cradle, the pivot mount having a pivot axis disposed perpendicularly with respect to the longitudinal axis of the brush so as to allow the brush to rotate about the pivot axis of the pivot mount.

2. The apparatus of claim 1 wherein the pivot mount supportably engages the hopper with the cradle.

3. The apparatus of claim 1 and further comprising:
a cradle in supportive engagement with the brush; and
a quick-release mechanism securing the brush to the cradle.

4. The apparatus of claim 3 wherein the quick-release mechanism comprises:
a spring loaded mandrel secured to one of the brush and the cradle; and
at least one receptacle disposed in the other of the brush and the cradle configured so as to supportably receive the mandrel.

5. The apparatus of claim 1 wherein the screen further comprises:
a screen portion;
a first support bar fixably attached to the screen portion and releasably secured to the hopper at a first mounting point;
a second support bar generally parallel to the first support bar, and releasably secured to the hopper at a quick-release second mounting point; and
wherein the first mounting point is disposed on one side of the hopper opening and the second mounting point is disposed on another second side of the hopper opening.

6. The apparatus of claim 1 wherein the second mounting point further comprises:
a spring biased mount, moveable with respect to the hopper such that overcoming the spring bias allows the first bar to be secured or unsecured from the first mounting point.

7. The apparatus of claim 1 further comprising:
a cradle rotatably supporting the brush; and
at least one bristle pattern disposed on an outer annular surface of the brush.

8. The apparatus of claim 1 wherein the screen further comprises:
at least one pattern formed by a mask over the screen.

9. The apparatus of claim 1 and further comprising:
a shutter disposed proximate the screen so as to selectively allow particles through the screen.

10. The apparatus of claim 1 and further comprising:
a feedback loop disposed so as to receive a signal from a monitoring device and vary the rate of dispensation of the particles.

11. The apparatus of claim 10, wherein the monitoring device comprises:
a source configured to emit radiation;
a detector disposed so as to receive radiation emitted from the radiation source;
a radiation path defined by the distance between the source and the detector, the radiation path disposed between the brush and the surface; and
a calculation device configured so as to compare the amount of radiation emitted by the source to the amount received by the detector.

12. The apparatus of claim 11, wherein the radiation is visible light.

13. The apparatus of claim 10, wherein the monitoring device comprises:
a power source;
an electrical circuit formed by the power source, particles disposed in the hopper, the surface, and particles disposed between the hopper and the surface; and
a calculation device configured so as to measure the amount of electrical current in the electrical circuit.

14. The apparatus of claim 10, wherein the monitoring device comprises:
at least one force sensor fixed to the hopper; and
a calculation device configured so as to measure the change in weight of the hoper.

15. The apparatus of claim 10, further comprising:
a cradle rotatably supporting the brush;
a drive mechanism engaged so as to provide motivating force to the brush; and
a feedback loop connected to the monitoring device so as to vary the amount of motivating force provided by the drive mechanism.

16. The apparatus of claim 1 wherein the surface is a particle surface of a streaming web and further comprising:
at least one nip roller disposed downstream along the web from the brush;
a liner secured to the web downstream along the web from the brush; and
wherein the liner is disposed between the particle surface of the web and the nip roller.

17. A method for dispensing particles onto a surface comprising:
holding the particles in a hopper having an opening;
dispensing a screen over the opening;
passing bristles of a brush across the screen;
drawing the particles through the screen with the brush; and
dispersing the particles into the air such that they settle onto the surface.

18. The method of claim 17 and further comprising:
rotating the brush about a longitudinal axis; and
pivoting the brush about an axis perpendicular to the longitudinal axis.

19. The method of claim 17 and further comprising:
holding the brush proximate to the screen using a cradle;
releasing the brush from the cradle using a quick-release mechanism; and
securing the brush to the cradle using the quick-release mechanism.

20. The method of claim 19 wherein the releasing step further comprises:
retracting a spring loaded mandrel fixably secured to one of the brush and the cradle from a receptacle disposed in the other of the brush and the cradle.

21. The method of claim 17 further comprising:
fixably securing a first support bar to the screen and releasably securing the first bar to the hopper on one side of the opening at a quick-release first mounting point;
fixably securing a second support bar to the screen such that the second support bar is generally parallel to the first support bar;
releasably securing the second bar to the hopper on an opposite side of the opening; and
disposing the second support bar generally parallel to the first support bar.

22. The method of claim 21 wherein the step of releasably securing the second bar further comprises:
translating a spring loaded moveable portion of the quick-release first mounting point away from a biased position;
attaching the first bar to the quick-release; and
allowing the spring loaded moveable portion of the quick-release first mounting point to return to the biased position.

23. The method of claim 17 and further comprising:
forming a series of bristle patterns on an outer annular surface of the brush.

24. The method of claim 17 and further comprising:
blocking the passage of particles through certain parts of the screen.

25. The method of claim 17 and further comprising:
monitoring a rate of dispensation of the particles.

26. The method of claim 25 wherein the step of monitoring further comprises:
emitting radiation from a source;
receiving the radiation with a detector;
defining a radiation path between the source and the detector;
disposing the radiation path through the dispersed particles; and
calculating the amount of dispersed particles by comparing the radiation emitted to the radiation received.

27. The method of claim 25 wherein the step of measuring further comprises:
electrically charging the particles in the hopper; and
calculating the current delivered to the surface by the charged particles.

28. The method of claim 25 wherein the step of monitoring further comprises:
weighing the hopper and particles before particles are dispersed;
weighing the hoper after particles are dispersed; and
calculating the amount of dispersed particles by comparing the weight of the hopper before dispersing particles to the weight of the hopper after dispersing particles.

29. The method of claim 24 and further comprising:
rotating the brush; and
altering the rotational speed of the brush according to the monitoring rate of dispensation.

30. The method of claim 16 and further comprising:
continuously translating the surface in one direction under the brush;
disposing a liner over the surface and settled particles; and
translating the liner between the surface and a nip roller.
